(19) United States
(12) Patent Application Publication
(10) Pub. No.: US 2006/0200409 A1
(43) Pub. Date: Sep. 7, 2006

(54) Method and system for trading in the future popularity of people, places, and things using pop future cards, contracts, and composites

(76) Inventor: Kevin R. McMahon, Akron, OH (US)

Correspondence Address: BROUSE MCDOWELL LPA, 388 SOUTH MAIN STREET, SUITE 500, AKRON, OH, 44311, US

(21) Appl. No.: 11/368,784

(22) Filed: Mar. 6, 2006

Related U.S. Application Data
(60) Provisional application No. 60/658,649, filed on Mar. 4, 2005.

(51) Int. Cl. G06Q 40/00

(52) U.S. Cl. 705/41

(57) ABSTRACT

A new and improved method of trading in the future popularity of people, places, and things is herein disclosed. The method includes issuing at least one unit associated with the person, place, or thing, assigning an original monetary value to each of the at least one unit, establishing an exchange wherein the value of each of the at least one unit is monitored, and allowing variability in the monetary value, the variability dependent upon the popularity of the person, place, or thing.

### I. BACKGROUND OF THE INVENTION

A. Field of Invention

This application claims priority to a provisional patent application, U.S. Ser. No. 60/658,649, entitled METHOD AND SYSTEM FOR TRADING IN THE FUTURE POPULARITY OF PEOPLE, PLACES, AND THINGS USING POP FUTURE CARDS, CONTRACTS, AND COMPOSITES, filed Mar. 4, 2005.

The present invention relates to a method of trading, and more particularly to trading in the future popularity of people, places, and things.

B. Description of the Related Art

A futures contract is a standardized agreement under which a contracting party undertakes to buy or sell a quantity and quality of an asset in the future at a price agreed to at the time of the transaction. Sellers of assets use futures contracts to lock in buyers at a fixed price to protect themselves from fluctuations in the price over time and to secure a profit margin between their selling and purchase costs. Additionally, those having an interest in a future event may obtain current capital to ensure the future event may occur. Futures contracts may be bought and sold in a futures exchange, which is a marketplace for trading. Individual futures contracts may be traded or the contracts may be grouped by, for example, type, relative risk or market and then the contracts within the group may be simultaneously traded. This grouping of contracts is known as a future contracts fund. Additionally, there are futures contract types known as options where the buyer has the option to buy or sell an asset at a specified price, known as the strike price, before an expiration date. Another type of a futures contract is the forward type where payment for the contract is due in full at the time of, or after, delivery of the asset, as compared to daily settlement of the contract.

Trading of futures contracts in futures exchanges has historically been performed by an open outcry method, where traders representing buyers and sellers stand in designated areas, known as pits, and call out bids and offers of sale and then execute trades. Computer-based electronic future trading systems are now available that allow posting of buy and sell offers, associated offer matching and trade execution.

Buyers and sellers of futures contracts are speculating on price movement of the asset. A buyer may purchase a futures contract anticipating a price increase, i.e., buying “long,” with subsequent resale at a higher price. If a buyer speculates that the price of an asset will drop, they can sell “short,” that is, attempt to profit in the subsequent sale of the contract by purchasing an off-setting contract at a lower price.

The use of futures contracts and trading thereof has been limited to assets such as physical commodities or financial instruments. A futures contract requires the delivery of a specific quantity of the asset to a buyer at the date of expiration of the contract. Futures contracts typically specify the amount, quality, date and location of delivery, means of delivery, method of payment, and futures exchange to be used. Due, in part, to the nature of the future exchanges used in the past, it has been necessary to standardize contract terms as well as the type and characteristics of the underlying asset so as to allow timely, accurate, and low cost transactions to be possible. Assets have to be separable into homogeneous units, i.e. identical in quality and quantity. If that is not possible, the asset may alternatively be required to be readily standardizable and capable of being graded. To-date, assets traded using futures contracts in a futures exchange have been tangible assets, i.e. commodities such as wheat, oil, pork bellies, or financial securities, that meet required asset criteria as required in an open outcry system. The development of computer trading future exchanges inherently permits transactions to occur more quickly and may accommodate more complex and varied future contract terms than previously possible with open outcry exchange systems.

For over a century, trading cards, typically associated with sports figures, have been collected by millions of people. Trading cards initially were designed as promotional tools, and were typically collected for fun. However, as time went by, and most of the older cards were destroyed, some of the cards were being sold for fairly large sums of money. This led to a boom in the 1980s of people buying trading cards as investment tools. The present invention seeks to combine the public's desire for investment, and the public's interest in hobbies and fascination with celebrities.

The present invention provides methods and apparatuses for trading in the future popularity of people, places, and things. The difficulties inherit in the art are therefore overcome in a way that is simple and efficient, while providing better and more advantageous results.

### II. DEFINITIONS

Asset—A resource having economic value that an individual, corporation or country owns or controls with the expectation that it will provide future benefit.

Card—a flat stiff usually small and rectangular piece of material (as paper, paperboard, or plastic) usually bearing information: as (1): POSTCARD (2): CREDIT CARD (3): one bearing a picture (as of a baseball player) on one side and usually statistical data on the other (4): one on which computer information is stored (as in the form of punched holes or magnetic encoding) (5): one bearing electronic circuit components for insertion into a larger electronic device (as a computer).

Composite—A grouping of equities, indexes or other factors combined in a standardized way, providing a useful statistical measure of overall market or sector performance over time. Also known as a “composite index”.

Contract unit—The actual amount of commodities represented by a single futures contract.

Exchange—A market in which securities, commodities, options, or futures are traded.

Futures contract—A contractual agreement, generally made on the trading floor of a futures exchange, to buy or sell a particular commodity or financial instrument at a pre-determined price in the future. Futures contracts detail the quality and quantity of the underlying asset; they are standardized to facilitate trading on a futures exchange. Some futures contracts may call for physical delivery of the asset, while others are settled in cash.

Individual—existing as a distinct entity. Within the definition of “individual” it is intended to be encompassed both living and dead individuals, as well as both real and fictional individuals.

Limit Order—An order in which an investor specifies a price to buy or sell.

Market Order—an order from an investor who wants to buy or sell a security at the best price currently available.

Option—A privilege sold by one party to another that offers the buyer the right, but not the obligation, to buy (call) or sell (put) a security at an agreed-upon price during a certain period of time or on a specific date.

Popularity—anything that brings the person, place, or thing to the public's, or a segment of the public's, attention.

Security—An instrument representing ownership (stocks), a debt agreement (bonds), or the rights to ownership (derivatives).

Stop Order—A stop order to buy becomes a market order when a transaction in the security occurs at or above the price after the order is represented. A stop order to sell becomes a market order when a transaction in the security occurs at or below the price after the order is represented.

Thing—an inanimate object distinguished from a living being; whatever may be possessed or owned or be the object of a right.

Trading Card—A card with a picture or design printed on it, often one of a set for trading and collecting.

### II. SUMMARY OF THE INVENTION

According to one aspect of the present invention, a trading system includes trading units based on the popularity and/or performance of people, places, or things.

In accordance with another aspect of the present invention, pop future cards can be purchased representing units in the future popularity of a person, place, or thing. “Pop future” is defined as the future popularity of people, places, or things. “Pop future cards” and “future cards” will be used interchangeably.

In accordance with another aspect of the present invention, futures contracts can be purchased related to the popularity and/or performance of a person, place, or thing.

In accordance with another aspect of the present invention, futures composites can be purchased related to the popularity and/or performance of a person, place, or thing.

In accordance with another aspect of the present invention, a method of monitoring popularity of people, places, or things includes issuing at least one unit associated with the person, place, or thing, assigning an original monetary value to each of the at least one unit, establishing an exchange wherein the value of each of the at least one unit is monitored, and allowing variability in the monetary value, the variability dependent upon the popularity of the person, place, or thing.

In accordance with another aspect of the present invention, the method further includes periodically posting, at the exchange, the current monetary value of the units.

In accordance with another aspect of the present invention, the method further includes issuing a trading card to a purchaser of at least one unit, the trading card having a description of the person, place, or thing on the card.

In accordance with another aspect of the present invention, the trading card further includes an electronic information storage device and an image of the person, place, or thing.

In accordance with another aspect of the present invention, establishing an exchange wherein the value of each of the at least one unit is monitored further includes setting an opening price for each unit at the beginning of each day and adjusting the price for each unit throughout the day.

In accordance with another aspect of the present invention, the adjustment of the price is based upon the increase or decrease in the popularity of the person, place, or thing.

In accordance with another aspect of the present invention, the person, place, or thing is chosen from the group comprising: an individual, a collection of individuals, an organization, a geographical location, a building, an inanimate object, and a monument.

In accordance with another aspect of the present invention, the electronic storage device contains information about the person, place, or thing and contains the number of units purchased.

In accordance with another aspect of the present invention, establishing an exchange wherein the value of each of the at least one unit is monitored, further includes providing means for buying the units and providing means for selling the units.

In accordance with another aspect of the present invention, the method further includes providing a database, the database containing the information regarding the purchased units, providing access to the database by a purchaser of the units, and providing a secure means by which the purchaser can manipulate the information.

In accordance with another aspect of the present invention, the means for buying and selling units is available via a global computer network.

In accordance with another aspect of the present invention, a trading card includes at least one description of a person, place, or thing, and a designation representing at least one unit, the unit having a variable monetary value, the variable monetary value tied to the popularity of the person, place, or thing.

In accordance with another aspect of the present invention, the card further comprises at least one image of the person, place, or thing, and an electronic information device, the device containing a code, the code containing the number of units.

In accordance with another aspect of the present invention, the electronic information device is updatable via a global computer network, and the device contains the variable monetary value of the units.

In accordance with another aspect of the present invention, a security trading system, the system includes at least one security related to the popularity of a person, place, or thing, means for assigning a variable monetary value to the security, means for updating the variable monetary value, means for selling the security, and means for buying the security.

In accordance with another aspect of the present invention, the security is purchased in units, wherein each unit is assigned the variable monetary value.

In accordance with another aspect of the present invention, the monetary value of the security is adjusted upwardly or downwardly depending upon the relative popularity of the person, place, or thing.

In accordance with another aspect of the present invention, the security is issued via a trading card, wherein the trading card has at least one image of the person, place, or thing, and the trading card has an electronic information device associated with the card, the device containing the number of units purchased.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, at least one embodiment of which will be described in detail in this specification and illustrated in the accompanying drawings which form a part hereof and wherein:

FIG. 1 shows a representative picture that could be on the front of a future card as described in the present invention; and,

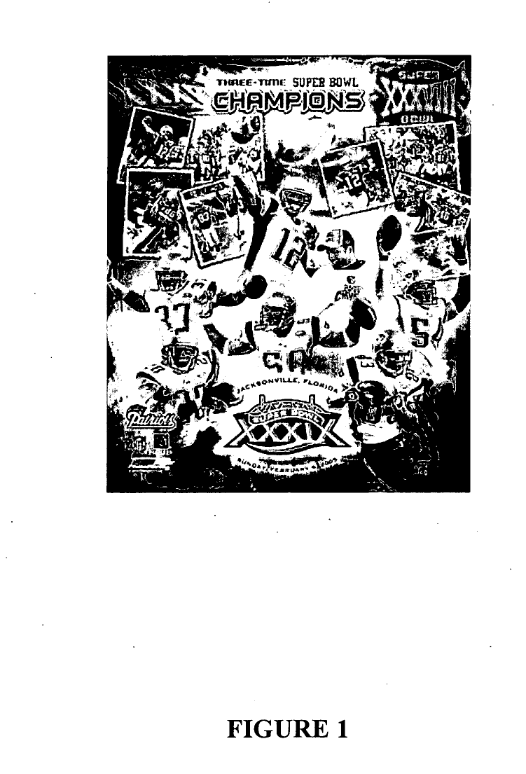

FIG. 2 is a perspective view of a smart card.

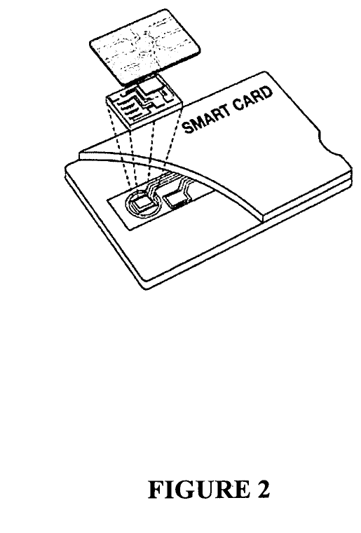

### IV. DESCRIPTION OF THE INVENTION

Referring now to at least one embodiment of the invention, pop future cards will be sold to the public and display the name and likeness of a famous person, place, or thing. In one embodiment of the invention, the future cards (in this application, the terms “future cards” and “trading cards” will be used interchangeably) are smart cards. A smart card is a card, the size of a conventional credit card, which incorporates an electronic chip. These cards can be memory only; memory plus a microprocessor; proximity where the card has to be held within 20 cm of the reader; vicinity where the card is between 10 cm and 2 meters of the reader; or distant contactless where the card is more than 2 meters from the reading device. The electronic chip in the smart card contains the number of units of the futures card, as well as the value of the units. In one embodiment of this invention, the smart card could be updateable via connection to a global computer network.

The pop future cards could be sold for LeBron James (or any other athlete), George W. Bush (or any other political figure), Elvis Presley (or any other entertainer), Sponge Bob (or any other fictional character), Mississippi River (or any other body of water), Chevrolet Corvette (or any other vehicle), Harry Potter (or any other film, television, or radio program or personality), The Ohio State University (or any other educational institution), Britney Spears (or any other entertainer), California (or any other state, province, canton, or country), New York City (or any other city, township, etc.), Hilton Head (or any other vacation spot), Grand Canyon (or any other geographic location), etc (the preceding list is intended for illustrative purposes only, and is not intended to limit the invention in any manner). In one embodiment of the invention, the pop future cards will be offered in an initial offering, wherein one unit of the famous person, place, or thing's popularity will equal $1.00. In this embodiment, the initial volume of units will be the permanent total number of units, not subject to increase or decrease. The pop future card, in another embodiment, has an electronic information device, which in this case is a magnetic strip, with information contained on it. The magnetic strip contains the number and value of units, and could contain other information related to the famous person, place, or thing. The future card, in this embodiment, is compatible with any computer and can be connected to a network. Once the future card has been issued, the units that it represents will trade on the open market and the unit value will rise or fall dependent upon how the public views the future popularity prospects of the famous person, place, or thing. It is also to be understood that the future card may not contain any magnetic or electronic devices or information. The card may simply list the number of units that have been purchased. In one embodiment, each card has a unique identification number associated with it, and imprinted on the card. Once an investor purchases the future card, the investor will contact the exchange and register the card with the exchange using the unique identification number. The exchange will verify the number and enter the registration of the card into an electronic database.

In this embodiment of the invention, the trading venue for the pop future cards will be a global computer network. Customers who own units will place their units up for auction on the global computer network, and other customers will bid on those units. The owner of the units can either auction off the entire card, containing all of the units, or he can auction a portion of the units on his card. The auction and the bidding will be driven by the popularity of the particular person, place, or thing, and the value of the units will be determined by the public's perception.

It is to be understood that the invention does not require a physical card, but could be any means of tracking unit volume and price per unit. Also, the magnetic strip on the card is only one embodiment of the invention, and any means of tracking the unit and price could be used, as long as chosen using sound engineering judgment. It is further to be understood that the invention is not limited to a $1.00 opening unit price, nor is the invention limited to a static unit volume.

In another embodiment of this invention, the units can be bought and sold similar to the method used on the New York Stock Exchange. For example, an investor decides to invest in the pop futures market. A second investor decides to sell a pop future card. The investors consult a broker who is a member of the exchange. They discuss a number of possible long-term investments. The first investor asks his broker for a quote—the highest bid (to buy) and the lowest offer (to sell) for a pop future card at any given time—on LeBron James. The second investor asks the broker for a quote on LeBron James. The brokers access an electronic market data system to obtain quotes on LeBron. Taking into account what he already knows about LeBron James—and after a discussion with his broker—the first investor instructs his broker to purchase 100 unites of LeBron James at the current market price. Or he goes to his online computer at his home or office and enters the order through his online account which links to the exchange. The second investor instructs his broker to sell 100 units of LeBron James at the current market price. Or the investor goes to his online computer and enters the order via an online account. The two brokers compete with other brokers to get the best price for their customers. The brokers agree on a price. The transaction is processed electronically, crediting the first investor's brokerage firm and debiting the account of the second investor's brokerage firm. Both investors receive a trade confirmation from their respective firms within a few days describing the trade, its terms and conditions, and the exact amount to be tendered or credited.

### EXAMPLE 1 (POP FUTURE CARDS)

10,000,000 units of the popularity of LeBron James of the Cleveland Cavaliers are issued at a face value of $1.00 per unit. A customer purchases 10 units of LeBron James for $10. The customer receives a pop future card with a picture of LeBron James, and a magnetic strip containing the units and unit value of the card. If LeBron James wins the NBA MVP award, his units may increase to $4.00 a unit, so now the customer owns $40 worth of LeBron James popularity. On the other hand, if LeBron James broke his leg, or receives negative publicity, the value of his units may drop below $1.00.

### EXAMPLE 2 (POP FUTURE CARDS)

A customer owns four pop future cards of the New England Patriots, which contain a total of 40 units and were purchased for $40. After the Patriots win the Super Bowl, the customer contacts the trading venue to offer two of his future cards, containing 20 units of the New England Patriots. Since the Patriots just won the Super Bowl, many people in the New England area want to “own” a piece of the Patriots. Over the course of five days, the units garner a high bid of $200. The customer sells his units, for a $180 profit, and the units of the Patriots have been established as being worth $10 per unit.

In another embodiment of the invention, the customer who purchases units in a famous person, place, or thing would not receive a physical card, but would have some record, electronic or otherwise, of his purchase of the units. These units could then be traded as above. In this embodiment, the record of the units purchased is stored on an electronic database, which is accessible via a global computer network. The purchaser would have an individual account, with an account number, and a password. The purchaser could access his account via the global computer network and purchase or sell units of the pop future card(s). In this embodiment, the value of each unit is available via a streaming download on the global computer network. The operation of the streaming download is well known in the art, and will not be further described herein.

In another embodiment of the invention, units are sold by the owner directly through the trading venue by using the most recently determined value of the units. In the example related to the Patriots, another customer could contact the trading venue and inform them that he wanted to sell 100 units of the Patriots. The offer is entered into the trading venue's system, and when a buyer who is willing to pay $10 per unit for 100 units is found, the sale is concluded. It is to be understood that any method of purchase, sale, and trading that is currently available for stocks or other securities can be used with this invention.

In another embodiment of the invention, pop future contracts are offered on famous people, places, or things. The pop future contracts are analogous to commodity futures contracts and will be created on the basis of the famous people, places, or things attaining certain objective performance levels. Any number of performance levels, or combination of performance levels could be used in this invention. The contracts could also be written such that only the top performer pays out. The value of the contracts, as with the futures cards, would be affected by public opinion. As the famous person, place, or thing, approaches a particular objective level the value of the contract would increase. The trading venue system is used to track the value of the contracts, as well as to buy and sell the contracts. A customer owning a future contract could offer the contract up for bid, and whatever the bid amount is, that would determine the new value for the future contract.

### EXAMPLE 3 (POP FUTURE CONTRACTS)

Pop future contracts are offered to investors for Tiger Woods, Ernie Els, Phil Mickleson, and Vijay Singh on the basis of where each will finish the PGA season on the total earnings list. Each player starts out with a contract worth $1.00. As the season progresses, and the players either win or lose, the value of the contract will increase or decrease. At the end of the season, the contracts values are determined by how well the golfers did that season. As with the previous embodiments, any method of buying or selling the contracts can be used, as long as chosen using sound business judgment.

### EXAMPLE 4 (POP FUTURE CONTRACTS)

Pop future contracts are offered to investors for Tiger Woods, Ernie Els, Phil Mickleson, and Vijay Singh on the basis of where each will finish the PGA season on the total earnings list. Each player starts out with a contract worth $1.00. At the end of the season, only contracts on the golfer who finishes at the top of the list pay out. The other contracts are worth $0.00.

In another embodiment of the invention, pop future composites can be issued in the same manner as pop future cards, except that the price of the pop future composites is tied to how individual people, places, or things perform on indices that reflect their popularity and performance in their respective field. As the pop future composite is adjusted up or down, owners of the composite would buy or sell at the adjusted price. The composite could be sold in the same ways as the future contracts and future cards.

### EXAMPLE 5 (POP FUTURE COMPOSITES)

A pop future composite is issued for Peyton Manning based on a composite index for NFL quarterbacks. The index includes quarterback rating, touchdown passes, passing yards, interceptions, number of completions, and current trading of pop future cards. Since Peyton Manning broke the single-season touchdown passes record in 2004, his future composite would have increased significantly based on the index.

Any of the cards, contracts, or composites can be sold at a trading venue or exchange. The exchange, in this embodiment, is an online trading house, wherein owners of the cards, contracts, or composites can purchase and/or sell their cards, contracts, or composites. The trading venue could operate as an auction site, similar to the auctions run by eBay®. In this embodiment, the trading venue could contain a listing of the various people, places, and things for which units are available, and the customer could click on a link to a particular person, place, or thing. Once the customer has chosen the person, place, or thing, the trading venue system provides them with the option of choosing to purchase a future card, future contract, or future composite. Once the customer has chosen which item to purchase, the system will inform them of the units available, and the price per unit. The customer can then choose how many units they would like to purchase. The transaction is completed in accordance with well known financial transaction methods, which will not be further described herein.

Once the transaction is completed, the customer will receive confirmation of the transaction, and will receive proof of ownership of what they purchased. In this particular embodiment, if they purchased a future card, they will receive a physical card with a representation of the person, place, or thing on the card. As with traditional trading cards, in one embodiment of the invention, different images may available for each of the people, places, and things. In this way, even if the units have been sold, and the card no longer has any value as a futures card, it may have some value as a traditional trading card.

In one embodiment of the invention, at the start of each trading day, a fair market price is established for each of the securities. The price will be based upon the popularity of the person, place, or thing. Then, during the day, current bids and offers are quoted to the various brokers. If there are temporarily more buy orders than sell orders for a particular pop future, or if there are more sell orders than buy orders, a broker will step in and sell or buy the pop future using his own firm's money. This is done by buying or selling against the trend of the market, until a price is reached at which public supply and demand are once again in balance.

It is to be understood that any person, place, or thing, whether alive or dead, past, present, or future, real, or fictional are contemplated by this invention. It is also intended to be included within the definition of popularity, both good and bad publicity. For example, if Maurice Clarett receives a prison sentence, this will affect his popularity.

However, it is to be understood that the descriptions and definitions of “trading card” in this invention are not intended to encompass stock certificates as they exist at the time of the filing of this application.

At least one embodiment has been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A method of monitoring and valuing popularity of people, places, or things, the method comprising:
issuing at least one unit associated with the person, place, or thing;
assigning an original monetary value to each of the at least one unit;
establishing an exchange wherein the value of each of the at least one unit is monitored; and,
allowing variability in the monetary value, the variability dependent upon the popularity of the person, place, or thing.

2. The method of claim 1, wherein the method further comprises the step of:
periodically posting, at the exchange, the current monetary value of the units.

3. The method of claim 2, wherein the method further comprises the step of:
issuing a trading card to a purchaser of at least one unit, the trading card having a description of the person, place, or thing on the card.

4. The method of claim 3, wherein the trading card further comprises:
an electronic information storage device; and,
an image of the person, place, or thing.

5. The method of claim 1, wherein establishing an exchange wherein the value of each of the at least one unit is monitored further comprises the steps of:
setting an opening price for each unit at the beginning of each day; and,
adjusting the price for each unit throughout the day.

6. The method of claim 5, wherein the adjustment of the price is based upon the increase or decrease in the popularity of the person, place, or thing.

7. The method of claim 6, wherein the person, place, or thing is chosen from the group comprising: an individual, a collection of individuals, an organization, a geographical location, a building, an inanimate object, and a monument.

8. The method of claim 4, wherein the electronic storage device contains information about the person, place, or thing and contains the number of units purchased.

9. The method of claim 1, wherein establishing an exchange wherein the value of each of the at least one unit is monitored, further comprises the steps of:
providing means for buying the units; and,
providing means for selling the units.

10. The method of claim 9, wherein the method further comprises the steps of:
providing a database, the database containing the information regarding the purchased units;
providing access to the database by a purchaser of the units; and,
providing a secure means by which the purchaser can manipulate the information.

11. The method of claim 10, wherein the means for buying and selling units is available via a global computer network.

12. A trading card comprising:
at least one description of a person, place, or thing; and,
a designation representing at least one unit, the unit having a variable monetary value, the variable monetary value tied to the popularity of the person, place, or thing.

13. The card of claim 12, wherein the card further comprises an electronic information device, the device containing a code, the code containing the number of units.

14. The card of claim 13, wherein the electronic information device is updatable via a global computer network, and the device contains the variable monetary value of the units and the card further comprises at least one image of the person, place, or thing.

15. The card of claim 12, wherein the person, place, or thing is chosen from the group comprising: an individual, a collection of individuals, an organization, a geographical location, a building, an inanimate object, and a monument.

16. A security trading system, the system comprising:
at least one security related to the popularity of a person, place, or thing;
means for assigning a variable monetary value to the security;
means for updating the variable monetary value;
means for selling the security; and,
means for buying the security.

17. The system of claim 16, wherein the security is purchased in units, wherein each unit is assigned the variable monetary value.

18. The system of claim 17, wherein the monetary value of the security is adjusted upwardly or downwardly depending upon the relative popularity of the person, place, or thing.

19. The system of claim 18, wherein the security is issued via a trading card, wherein the trading card has at least one image of the person, place, or thing, and the trading card has an electronic information device associated with the card, the device containing the number of units purchased.

20. The system of claim 19, wherein the person, place, or thing is chosen from the group comprising: an individual, a collection of individuals, an organization, a geographical location, a building, an inanimate object, and a monument
